(19) United States
(12) Patent Application Publication
(10) Pub. No.: US 2015/0187006 A1
(43) Pub. Date: Jul. 2, 2015

(54) SYSTEM FOR CREATION OF AN INTEREST ONLY STRIPS INDEX

(71) Applicant: SB INDEXES, LLC, Wilmington, NC (US)

(72) Inventors: RONALD RYAN, JUPITER, FL (US); Stephen Tanzer, Eads, TN (US); Robert Judge, Chagrin Falls, OH (US)

(21) Appl. No.: 14/636,300

(22) Filed: Mar. 3, 2015

Related U.S. Application Data
(63) Continuation-in-part of application No. 13/705,569, filed on Dec. 5, 2012, now abandoned.
Application No. 13/705,569 is a continuation of application No. 13/442,922, filed on Apr. 10, 2012, now Pat. No. 8,452,684.

(51) Int. Cl. G06Q 40/04

(52) U.S. Cl. CPC G06Q 40/04

(57) ABSTRACT

A computer system for creating an index of interest only strip pools comprising: (1) forming one or more candidate pools based on specific characteristics of interest only pools; (2) determining one or more selection criteria for including one or more candidate pools in an index; (3) comparing the one or more candidate pools to the selection criteria; (4) and if the criteria is met, then (5) weighting the pool and (6) storing said pool in the index.

### CROSS-REFERENCE TO RELATED APPLICATIONS

This is a continuation-in-part of and claims the priority benefit under 35 U.S.C. 120 of: U.S. patent application Ser. No. 13/705,569 entitled A METHOD AND SYSTEM FOR CREATION OF AN INTEREST ONLY STRIPS INDEX, filed Dec. 5, 2012, and U.S. Pat. No. 8,452,684 A METHOD AND SYSTEM FOR CREATION OF A FLOATING RATE POOLED INDEX, filed Apr. 10, 2012, the entire disclosures of which are hereby incorporated by reference herein.

### FIELD OF INVENTION

The invention relates generally a computer system for creating an interest only index as implemented by a software program.

### BACKGROUND

An index is a statistical composite that is used to indicate the performance of a market or a market sector over various time periods. Examples of indices that are used to gauge the performance of stocks, bonds and other securities in the United States include the Dow Jones Industrial Average, the National Association of Securities Dealers Automated Quotations (NASDAQ) Composite Index, the New York Stock Exchange (NYSE) Composite Index, etc.

An interest only (IO) strips generally refers to the interest portion of mortgage, Treasury or bond payment, which is separated and sold individually from the principal portion of those same payments. Also for example, the periodic payments of several bonds can be “stripped” to form synthetic zero-coupon bonds. Financial institutions through its dealers, often strip and restructure bond payments in an effort to earn arbitrage profits. Zero-coupon Treasury strips are an important component in financial calculations and bond valuations. For example, the zero coupon or spot-rate Treasury yield curve is used in option-adjusted spread (OAS) calculations and for other valuations of bonds with embedded options.

Although within financial markets there exists indexes that track products such as residential Mortgage Backed Securities (MBS) IO strip securitizations, no known index for interest only strips currently exist.

By way of example a guaranteed portion of the SBA 7 (a) Pooled loan is eligible to be sold and then pooled into securities under the SBA 7 (a) Pooling Program. The SBA Pools are referred to as pass-through securities where pool assemblers actively bid on the loans, aggregate the loans thus acquired through bidding, and optionally pass them into the securities market for trading. All the pools are issued with an original face amount of the bonds. By way of example, 10 individual loans may comprise a $10,000,000 pool, whereby a monthly principal and interest paid by the borrowers of the underlying loans is passed through to an investor in the pool, based on the investor's pro rata share of the pool.

The guaranteed portion of pooled loans are eligible to be sold and then pooled into securities under various banking laws. In some instances, pools are referred to as pass-through securities where pool assemblers actively bid on the loans, aggregate the loans thus acquired through bidding, and optionally pass them into the securities market for trading. All the pools are issued with an original face amount of the bonds. By way of example, 10 individual loans may comprise a $10,000,000 pool, whereby a monthly principal and interest paid by the borrowers of the underlying loans is passed through to an investor in the pool, based on the investor's pro rata share of the pool.

Some pools amortize and are issued with an original face amount of the pool and begin with a factor of 1.0000. Each month following the issuance month, as principal is paid down by the borrower, the factor is reduced. When the last dollar of principal is paid back the factor will be 0.000000. A factor is calculated by dividing the current face amount of the pool by the original face amount of the pool.

Currently, there are no reliable interest only pool indices to assist the market in making considered judgments about investing in certain pools. An index of IO issued pools would provide investors a reliable bond-like investment if an index was constructed from pools with certain characteristics. Therefore, a need exists to create the universe of pools having certain characteristics and from that universe a selection process for inclusion of these pools in an index that reflects the performance to pools held for investment. The magnitude and complexity dealing with the dynamics of such pools also necessitates an automation process by which the pools having certain characteristics are identified and the application of selection criteria to qualify only those pools that produce an investor quality index.

### SUMMARY OF THE INVENTION

The present invention includes a computer system for creating an index fund based on interest only assets or cash flow from pools or loans including a computer processor for forming one or more candidate pools based on specific characteristics of a particular type of interest only pool; (2) a computer processor, executing software for determining a selection criteria for including one or more of these candidate pools in an index; (3) a computer processor and program for comparing the one or more candidate pools to the selection criteria, (4) and if the selection criteria are met, then (5) a computer processor and computer program for weighting the pool and (6) storing said pool in the index.

In yet another embodiment the invention includes a computer system for creating an index fund based on interest only assets or cash flow from pools or loans including a computer processor for forming one or more candidate pools based on specific characteristics of an interest only pool and based on the index creating a physical asset, securitizing the loan and stripping from the guaranteed loan portion.

The present invention includes a non-transitory computer-readable medium having stored thereon computer-readable instructions for (1) forming one or more candidate pools based on specific characteristics of (a) interest only pools; (2) determining one or more selection criteria for including one or more candidate pools in an index; (3) comparing the one or more candidate pools to the selection criteria, (4) and if the selection criteria are met, then (5) weighting the pool and (6) storing said pool in the index.

The invention further includes a computer program interface embodied on a computer readable medium for creating an index for loan portfolios comprising: a first interface for determining strip index eligibility and placing strip information into data arrays; second interface for calculating principal interest and returns for each eligible pool; calculate total returns for strip indexes; calculate index values based on daily returns; copy results to a spreadsheet and reset daily returns to zero.

The invention further relates to a database having a built-in delay containing an index of interest only pools.

The invention further relates to a database containing interest only pools weighted by the actual outstanding balance of eligible pools.

The invention further relates to a database containing eligible pool weighted based upon the index rules for liquidity, adjusted for the current month's factor for each pool and weighted in the indexes based on the current balance of the pool divided by the total amount of loan balances in the index.

The invention further relates to a database containing of an index comprised of two sub-indexes determined by two distinct maturity cells.

The invention further relates to a database containing of an index portfolio that is rebalanced at month-end for index rules, such as established by the selection criteria.

### BRIEF DESCRIPTION OF THE DRAWINGS

Understanding of the present invention will be facilitated by consideration of the following detailed description of the preferred embodiments of the present invention taken in conjunction with the accompanying drawings wherein:

FIG. 1 is a block diagram of a computer system for creating and managing interest only pooled indexes according to an embodiment of the present invention;

FIG. 2 is a flow chart of a computer process for creating interest only pooled indexes according to an embodiment of the present invention;

FIG. 3 is a flow chart of a computer process for creating interest only pooled indexes according to an embodiment of the present invention.

FIG. 4 is a spreadsheet of a computer process for creating interest only pooled indexes according to an embodiment of the present invention.

FIG. 5 is a flow chart of a computer process for creating interest only pooled indexes according to an embodiment of the present invention.

### DETAILED DESCRIPTION

It is to be understood that the figures and descriptions of the present invention have been simplified to illustrate elements that are relevant for a clear understanding, while eliminating, for the purpose of clarity, many other elements found in computing systems and computer process of making computations. Those of ordinary skill in the art may recognize that other elements and/or steps may be desirable in implementing the present invention. However, because such elements and process steps are well known by those of ordinary skill in the art, and because they do not facilitate a better understanding of the present invention, a discussion of such elements and steps is not provided herein.

The following description includes the best mode of carrying out the invention. The detailed description is made for the purpose of illustrating the general principles of the invention and should not be taken in a limiting sense. The scope of the invention is determined by reference to the claims. Each part is assigned, even if structurally identical to another part, a unique reference number wherever that part is shown in the drawing figures.

While the present invention is described with reference to the illustrative embodiments, this description is not intended to be construed in a limiting sense. Various modifications of the illustrative embodiments, as well as other embodiments of the invention, will be apparent to those skilled in the art on reference to this description. It is therefore contemplated that the claims will cover any such modifications or embodiments as fall within the true scope of the invention.

Although over different periods, requirements for pool parameters based upon bank practices and regulation can change, by way of example, as of January 2011, pools may have had the following characteristics: (a) a minimum original pool size of $1.0 million, (b) a minimum of four (4) loans in a pool, (c) that no single loan could consist of more than 25% of a pool for standard pools, (d) that no single loan could consist of more than 10% of a pool for Weighted Average Coupon (WAC) pools, (f) a maximum difference in borrower rates would be limited to 2%, (g) all loans in a pool required a monthly repayment schedule, (h) loans could vary in remaining maturity by no more than 30% for standard pools, and (i) prepayment penalties on loans with original maturities of 15 years of longer.

Certain types of loans have a loan amortization of monthly principal payments in addition to possible prepayments. Such principal prepayments are referred to herein as the constant prepayment rate (CPR). The CPR is calculated as the total dollar amount of notional value loan payoffs as an annualized percentage of the total outstanding notional loan value. The principal pay-downs (amortization plus prepayment) are reported with a two month lag, such that the pay-down return, for example February is based on the reported December prepayment data. The CPR is sometimes referred to as the prepayment speed. High prepayment speed CPR will reduce the income to the investor or lender.

Typically some currency based variable rate loans are originated at between zero (0) and a maximum number of basis points over the set base rate. By way of example, loans are originated at between zero (0) and 275 basis points over the base rate published in the Wall Street Journal (also referred to as Prime or Libor). The maximum rate that can be charged on most fixed rate loans may be fixed, as by way of example, 275 basis points above the current Prime or Libor rates. Exceptions may exist for loans under a certain amount, as for example, $50,000, that can be assessed an additional 200 basis points rate (e.g., 200) making the max rate Prime/Libor bases rates (e.g., +475) basis points for the smaller loans. By way of example, when the guaranteed portion of a loan is sold in the secondary market, the lender retains a servicing fee typically greater than or equal to 100 basis points, making the maximum rate that can be offered for sale on a variable rate loan, Prime+a basis, such as Prime+1.75%. By way of example, an initial purchaser can securitize the guaranteed portion of a loan into an individual guaranteed interest certificate through a fiscal and transfer agent (FTA) at this rate, less the FTA's fee and the a loan program fee. By way of example the variable rate loan Prime+a basis less the FTA's fee and a program fee may be set at 55 basis points of a guarantee fee and 12.5 basis points for an FTA Fee, the sum of the two fees equal to 67.5 basis points. The purchaser also may “strip” a portion of the interest rate from the guaranteed loan portion, creating what is called an “originator fee” or “interest-only strip”, and securitize the guaranteed loan portion at a lower interest rate.

These originator fee or interest-only strip assets are created by pool assemblers and at their option at the time of pooling the loans, may be converted into pass-through securities. By way of example and not limitation, each originator fee ownership is referenced by the issuance of a Confirmation of Originator Fee, COOF (analogous to a stock certificate) that details the characteristics of that particular originator fee and to whom it is registered. By way of example and not limitation, the maturity date, the balance of the loan at the time of issuance, the note date and the rate of interest stripped from the guaranteed loan. Once stripped the rate of interest remains fixed for the term of the loan. If the underlying loan from which the originator fee was stripped is a floating rate loan and the investor interest rate increases or decreases due to the underlying base index increasing or decreasing the originator fee coupon or interest rate would not change. All of these originator fees are stripped from the guaranteed portion of the loans.

By way of example, the investment industry offers a product referred to as the Receipt for Multiple Originator Fees or RMOF, where many COOFs are bundled into one certificate for ease of accounting and reporting.

When a pool assembler prepares loans for pooling it has the ability to manage the amount of premium and interest available associated with the loans being pooled. As an example: assume that the cost for the loans was $117.50 and the available net rate was Prime+1.075% margin with a maturity of 25 years. The pool assembler could strip interest off to create a lower coupon and lower price to meet the investor demands. If the investor did not want to pay more than $110 for the investment in the pool, the pool assembler could reduce the pool rate to Prime less 0.675% and sell the pool to the investor at $110. To do this the pool assembler would strip interest from the loans in the amount of 1.75% (1.075% less 0.675%)) equals 1.75%.

The computer creation of the family of indexes described herein is to offer a benchmark of performance for the security market place. This benchmark could be used for, among other things: (a) as a basis of investment direction of a particular mutual fund, hedge fund or ETF based on the inventive family of indexes; (b) as a tradeable index to offer investors a hedging tool for a specific asset class of securities; (c) for the investment market, analogous to ABX index for the sub-prime mortgage securities market; (d) a benchmark for the physical asset of originator fees within the market place. The performance of the underlying COOF physical asset may be derived from the prepayment behavior of (a) pool securities' market. In one embodiment the inventive family of indexes herein represents this performance from the time of the creation of the physical asset through the pooling and securitization of loans, COOFs or RMOFs. Those skilled in the art of investments of COOFs or RMOFs know how to create the physical assets, securitize the loans and strip from the guaranteed loan portion and then pool investments for trading in the appropriate market place.

By way of example and not limitation, the creation of a portfolio of securitized COOFs, having and index based upon an IO loans as disclosed herein serves as one embodiment of the present invention. The securitized COOFs represent physical assets, which are stripped from the guaranteed loan and then pooled, for investment in the appropriate market place and valued according to the pool index as further set forth in yet another embodiment of the invention described herein. Those skilled in the art of investments of COOFs or RMOFs know how to securitize loans and strip from the guaranteed loan and then pool investments for trading in the appropriate market place.

In one embodiment, the index herein is composed of strips synthetically created, as set forth below, from Floating Rate Pools that qualify to be included in the Floating Rate Pool Index. Each Pool and subsequent Interest strips are US dollar denominated. All IO strips included in the index have the Full Faith and Credit of the United States of America. All loan pools, from which the IO strips are created, have timely Principal and Interest provided through the Master Reserve Fund facilitated by a fiscal and transfer agent. All eligible pools must have remaining loans greater than 4, a factor greater than, or equal to 0.25% and no cap or floor on the pool coupon. The index does not allow “pool of pools” or private securitizations of loan Pools or IO strips to be included.

Indices may, for example, serve as barometers for a given market or industry and benchmarks against which financial or economic performance is measured. The value of any given index may be arbitrarily set, just as the total shares of all securities in the index may be arbitrary. For ease and clarity throughout this document, however, the present embodiment presumes the value of the subject index equals 100. Furthermore, the selection criteria may over time change depending on new government laws, regulations and rules.

An index may be derived from a subset of a universe or pool of securities meeting at least one selection criterion, and may optionally be weighted according to another selection criterion. Although over different periods characteristics for pools can change, by way of example, (a) pools typically exhibit the following characteristics: (a) monthly principal P&I, (b) guaranteed timely P&I on a date certain such as the 25^{th} day of the month after an 85 day delay, (c) adjustable rate reset on a date certain such as the first business day of each month or calendar quarter, (d) due to a monthly or quarterly reset, some pools have 30 day or 90 day index durations, and (e) lending institution recasts the amortization of each pool based on the final maturity of the pool and the net pool interest at each reset.

The index uses CPRs calculated specifically for each index based on its characteristics and calculated on its discreet prepayments. The index weighted average 12 month CPR is then based on that specific sub-index. For example, an “All Pools Equal Weighted Index” uses each underlying index qualified pool's actual 12 month CPR and equally weights them using the same original face for each pool (currently $10 million), as set out in the Index Rules, adjusted for the current months factor, and calculates the historical weighted average 12 month CPR. This same methodology is used for all six sub-indexes each month.

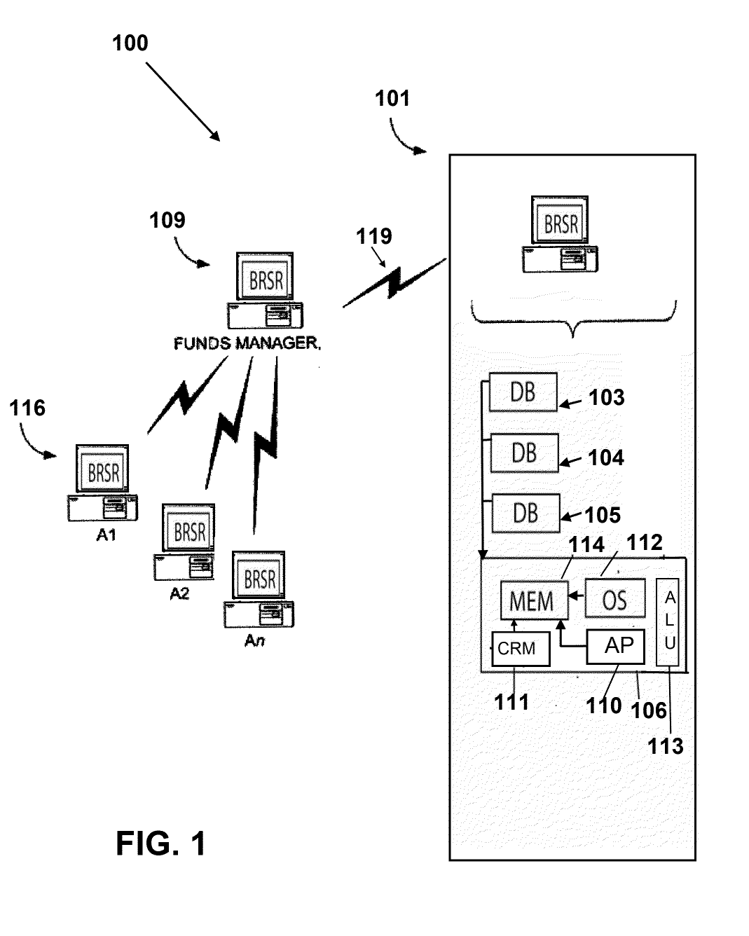

FIG. 1 of the present invention relates to a system 100 for providing an interest only pooled index including: comprising: (1) a computer processor 101 for forming one or more candidate pools based on specific characteristics of interest only loan pools; said processor storing in a first database 103 loans having specific characteristics of interest only loan pools; (2) said computer processor storing a selection criteria in a second database 104 for use in determining the suitability of including the one or more candidate interest only pools in an index; (3) said computer processor testing if the selection criteria are met by the one or more candidate pools, and if met then (5) weighting the pool and (6) storing in a third database 105, the pool thus forming the index.

Computer 101 includes a central processor unit (CPU) 106 having a memory 114, an arithmetic logic unit (ALU) 113, and input/output (I/O) devices (not shown) for accessing the databases 103, 104, and 105, executing an applications program 110 that determines the selection criteria for selecting which pools are included in the index, a memory 114 that stores the applications program, an operating system 112, and the database data used during comparisons and calculations required to carry out the inventive computer process herein. The computer 101 also has the capability to communicate with other computer processors 109 via channel 119 utilizing direct telephone, satellite or Internet communication. Computer 109 may communicate with workstations 116, A₁, A₂ . . . Aₙ through which various funds, equity markets and other investments and the interest only pool indexes detailed herein.

The computer 101 may include any one or a combination of a personal computer, a mouse, a keyboard, a computer display, a touch screen, LCD, voice recognition software, or other generally represented by input/output devices required to implement the above functionality.

The software that executes a preferred embodiment of the invention resides in a non-transitory computer-readable medium (CRM) 111 such as exemplified by memory 114 having stored thereon computer-readable instructions for implementing the computer process for: (1) forming one or more candidate pools based on specific characteristics of (a) floating loan pools; (2) determining a selection criteria for including one or more candidate pools in an index; (3) comparing the one or more candidate pools to the selection criteria, (4) and if the criteria is met, then (5) weighting the pool and (6) storing said pool in the index. The non-transitory computer-readable medium as exemplified by memory 114 having stored thereon computer-readable instructions commonly referred to as a program also may include program elements such as an operating system, a database management system and device drivers that allow the processor to interface with computer peripheral devices (e.g., a video display, a keyboard, a computer mouse, etc.).

Database 103 maintains the candidate pools having certain qualified characteristics, against which the selection criteria will be compared to determine if the particular pool in the candidate pool will be included in the index. The database 104 maintains the selection criteria for inclusion and exclusion of the interest only pool from the index. Database 105 contains the index.

Computer memory 114 stores and maintains the criteria for weighting the indexes chosen for the indexes. Computer memory 114 also stores and maintains the data for the calculation of the daily index as such calculation relates to: income return, principal and interest return, price return, daily total return and index levels.

The computer 101 also contains within its memory 114, an operating system 112, and code for carrying out various functions in connection with embodiments of the invention herein as well as the databases 103, 104 and 105, and to store data relevant to calculations as associated with determining the composition of the index. Computer 101 includes at least one central processor or CPU 106, at least one communication port or hub, at least one random access memory (RAM), at least one read-only memory (ROM). Typically the computer 101 is a conventional standalone computer however, it may alternatively function as a server whose operation may be distributed across multiple computing systems and architectures, that combined achieve the function described herein as to creating an interest only index.

The CPU 106, such as one or more conventional microprocessors and one or more supplementary co-processors such as math co-processors. Additionally the CPU 106 has means such as arithmetic logic unit (ALU) 113 for calculating and logical registers for addressing and retrieving and storing data in the one or more databases. The CPU 106 typically is in communication with a communication port through which the CPU 106 communicates with other devices such as other servers, user terminals or devices 109. The communication port may include multiple communication channels 119 for simultaneous communication with, for example, other processors, servers or client terminals. As stated, devices in communication with each other need not be continually transmitting to each other. On the contrary, such devices need only transmit to each other as necessary, may actually refrain from exchanging data most of the time, and may require several steps to be performed to establish a communication link between the devices.

The CPU 106 also is in communication with one or more data storage devices. The data storage devices may comprise an appropriate combination of magnetic, optical and/or semiconductor memory, and may include, for example, RAM, ROM, flash drive, an optical disc such as a compact disc and/or a hard disk or drive. The processors and the data storage devices each may be, for example, located entirely within a single computer or other computing device; or connected to each other by a communication medium, such as a USB port, serial port cable, a coaxial cable, a Ethernet type cable, a telephone line, a radio frequency transceiver or other similar wireless or wired medium or combination of the foregoing.

The data storage devices such as store databases 103, 104 and 105 and memory 114 may store, for example, (i) the program (e.g., computer program code and/or a computer program product) adapted to direct the processor in accordance with the present invention, and particularly in accordance with the computer processes described in detail hereinafter; (ii) the databases (103,104, 105) adapted to store information that may be utilized to store information required by the program. The databases include multiple records, each record including fields specific to the present invention such as interest only pools, selection criteria, financial objectives, indexes, and report data, etc.

The program may be stored, for example, in a compressed, an uncompiled and/or an encrypted format, and may include computer program code. The instructions of the program may be read into a main memory of the CPU 106 from a computer-readable medium other than the data storage device, such as from a ROM or from a RAM. While execution of sequences of instructions in the program causes the processor to perform the process steps described herein, hard-wired circuitry may be used in place of, or in combination with, software instructions for implementation of the processes of the present invention. Thus, embodiments of the present invention are not limited to any specific combination of hardware and software.

Suitable computer application program 110 code may be provided for performing numerous functions such as alternative steps of invention. The computer program code required to implement the above functions (and the other functions described herein) can be developed by a person of ordinary skill in the art, and is not described in detail herein.

The term “computer-readable medium” as used herein refers to any medium that provides or participates in providing instructions to the processor of the computing device (or any other processor of a device described herein) for execution. Such a medium may take many forms, including but not limited to, non-volatile media, volatile media, and transmission media. Non-volatile media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

In addition to memory 114, various forms of computer readable media may be involved in carrying one or more sequences of one or more instructions to the processor (or any other processor of a device described herein) for execution. For example, the instructions may initially be carried or reside on a magnetic disk of a remote computer. The remote computer can load the instructions into its dynamic memory and send the instructions over a router, an Ethernet connection, direct cable line, or even a telephone line using a modem. A communications device local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

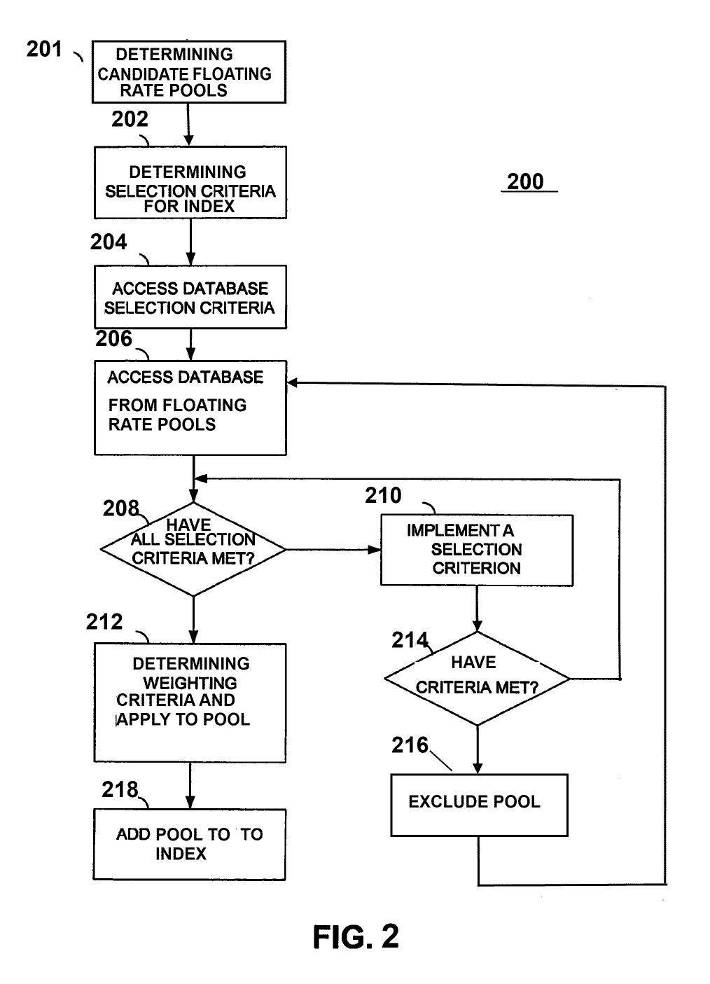

FIG. 2 illustrates computer process 200 a non-limiting embodiment of the invention, utilizing a selection criteria indicated above, wherein step 201 includes creating database 104 from the universe of loan pools to form candidate pools by determining if a particular pool meets general and specific characteristics, such as by way of example it: (A) is an loan based on U.S. dollar guaranteed interest only pool, (B) meets the full faith and credit backed by the U.S. government, (C) states principal and interest, where interest accrues uses a 30/360 day count convention, (D) has a maturity greater than a given number of years, by way of example and not imitation, one (1) year and a remaining number of loans greater than a given factor, by way of example and (E) not limitation a factor of 0.25%, (F) a minimum pool loan count of at least a given amount, by way of example and not limitation, five (5), has a liquidity value greater than a given amount, such as by way of example and not limitation $10,000,000, and (G) has an average loan size greater than a specified amount, by way of example and not limitation, $250,000, (H) is not a “pool of pools” or private securitization of pools or IO (Originator fees), or COOF, RMOF, (I) is not a private securitizations of existing pools.

Following identification of the pools having the general and specific qualifying characteristics, in step 201, the computer process then it determines if those loans meet a list of selection criteria in Determining Selection Criteria for Index step 202.

One embodiment of the invention utilizes, as a selection criteria in step 202, a rule of inclusion in the index that to remain in the index as an eligible pool a minimum of five (5) loans remain with a 0.25 factor or greater.

One embodiment of the invention, includes as selection criteria in step 202, a rule of inclusion in the index has a onetime Average Loan Size. This calculation is accomplished only at the time the pool is tested for inclusion in the index for the first time. By way of example, the calculation may be a simply division of the original face amount of the entire issue and divided by starting load count of the issue. The result must be greater than a fixed dollar amount.

Furthermore, a selection criteria in step 202 for inclusion in the index is that a pool have loan count that does not fall below five (5) or a pool factor that falls below 0.25%. If, initially or at the end of each month, in which the specific pool breaks the loan count or factor index, the pool is ineligible for inclusion in the index. No issue shorter that a fix year period, by way of example 10 years to maturity, can enter the indexes.

On a scheduled basis, as for example, each month, a new interest only pool is reviewed for Index Eligibility in the following order: Each month's new Floating Rate Pools will be reviewed for Index Eligibility by the following order:
First: Original Size of the Pool.
Second: No cap or floor on the pool coupon.
Third: Maturity years equal to, or greater than, 10 years (120 months).
Fourth: Minimum Loan Count.
Fifth: Minimum Average Starting Loan Size (Original Pool size/Original Loan Count)>=$250,000.
Sixth: Determination of Maturity Cell (less than or equal to 15 years or Greater than 15 years).

In step 202 each month every pool in the index the previous month will be reviewed for continued eligibility for the index using the following criteria:

First: Every pool evaluated for a current factor greater than or equal to 0.25.

Second: Every pool evaluated for 5 remaining loans remaining minimum.

In Access Database Selection Criteria step 204 the computer 101 program 110 accesses database 103 containing the specific selection criteria set forth above. In Access Database From interest only pools step 206 the computer 101 program 110 accesses database 103 containing a candidate interest only pool. In “Have All Selection Criteria Met” step 208 the computer 101 program 110 determines if the selected candidate pool has met each selection criteria set forth in step 202 and if not then the computer 101 program 110 chooses one of the criterion listed in step 202 and in “Criteria Met” step 214 tests if the selection criterion has been met, and if not then “Exclude Pool” step 216 excludes the pool and the process of selecting a pool for inclusion in the index begins again at step 206, whereby another pool is selected. If the “Has Criteria Met” step 214, indicates that the criteria has been met then the computer 101 program 110 checks the pool against another selection criterion in the list as provided in step 202. The process continues until either a pool is excluded in step 214 or all the selection criteria established in step 202 have been met by the particular pool. The selected pool is then weighted in step 212 and added to the database 105 as an indexed pool in step 218.

The index is weighted by the actual outstanding balance of eligible pools. Each eligible pool is weighted based upon the index rules for liquidity, adjusted for the current month's factor for each pool and weighted in the indexes based on the current balance of the pool divided by the total amount of loan balances in the index. In “Determine Weight Criteria” and Apply to Pool step 212 the computer 101 program 110 accesses from memory a factor to adjust the liquidity of the pool for the current month based on the current dollar loan balance of the pool divided by the total amount of the loans balances in the index. Once the pool is weighted it is stored in memory with an associated weight parameter in database 105.

The index is made up of two sub-indexes determined by two distinct maturity cells: as by way of example 10.00 to 15.00 and 15.01 to 25 years. Once a pool is in a specific maturity cell, it will remain regardless of the remaining maturity. The two cells separate real estate loans (>15 years) from working capital, plant and equipment loans (<15 years). Historically borrowers have demonstrated different payment behavior for each category of funding. The maturity cells segregate loan categories to track their performance; however, both sub-indexes are combined to create the interest only pool market performance.

The index is rebalanced at month-end for index rules, i.e., the computer process from steps 206 through 218 is repeated using the portfolio of pools stored in database 105 that were previously included and exist in the index. New issues may enter at month-end due to selection criteria index rules. Issues may also leave at month-end due to selection criteria index rules.

Once the index is established the index of pools is monetized and defined in terms of its quantifiable parameters as follows by way of example and not limitation the following steps 1 through step 9 below:

(1) All pools enter the index priced on the offering side. All pools already in the index are priced daily on the bidding side. All IO Index pricing is driven by the valuations of the pools, included in the Pool Index and from which the IO Index assets are derived.

(2) Yields are calculated based upon the last 12 months CPR using a discounted cash flow method (DFC). Pools may have a built in delay as for example an 84 day delay of which 54 days are without interest.

(3) Income Return equals: 100 times (End Accrued less Beginning Accrued plus Interest Payment) divided by the Beginning market Value.

(4) Principal Return equals 100 times (Principal Payment less Principal Payment times Beginning Price) divided by Beginning Market Value.

(5) Price Return equals 100 times (End Principal Balance times End Price) less End Principal Balance times Beginning Price) divided by Beginning Market Value.

(6) Daily Total Return equals 100 times (End Market Value divided by Beginning Market Value less one).

(7) End Market Value equals (End Principal Balance times End Price) plus End Accrued plus Interest Payment.

(8) Begin Market Value equals (Begin Principal Balance times Begin Price) plus Begin Accrued.

(9) All index levels start at 100 and are based on the daily total return behavior of each index. Total returns are based on price return plus income return plus principle return. Each index total return is calculated daily. The daily returns are reinvested and compounded back into each index on a multiplicative basis, based on the formula:

Beginning Index Level times (1 plus Daily Return divided by 100)=End Index Level.
By way of example and not limitation: (1+1.55/100)=101.55 where:
Begin Index Level=100.00
Daily Return=1.55%

(10) Cumulative Total Return equal 100 times (Ending Index Level divided by Beginning Index Level less 1). By way of example and not limitation:

100*(101.55/100.00)−1=1.55%

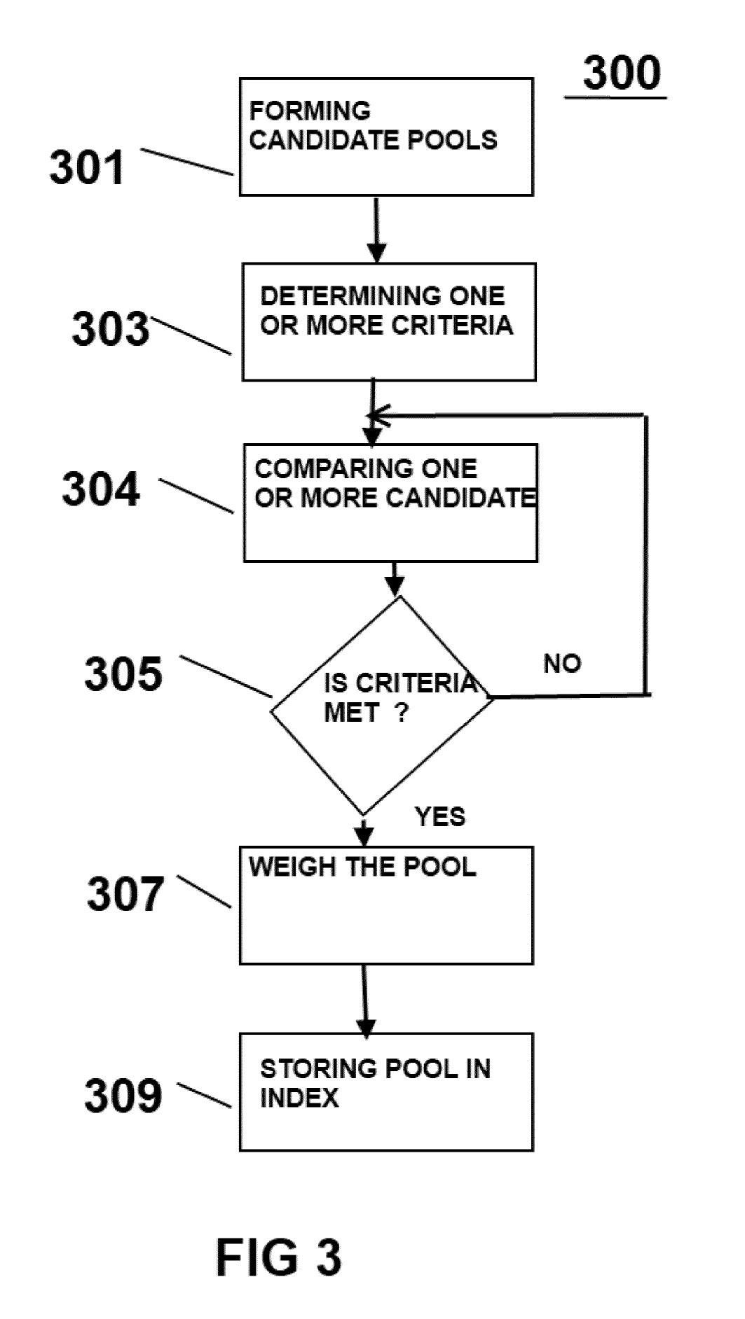

Referring to FIG. 3, a preferred embodiment a computerized computer process 300 is operable in a computer system for creating an index of interest only strip loan pools, said computer process causing said computer system to execute the steps of: (1) forming 301 one or more candidate pools based on specific characteristics of interest only loan pools; (2) determining 303 one or more selection criteria for including one or more candidate pools in an index; (3) comparing 304 the one or more candidate pools to the one or more selection criteria; (4) and if the selection criteria 305 are met, then (5) weighting 307 the pool; and (6) storing 309 said pool in the index.

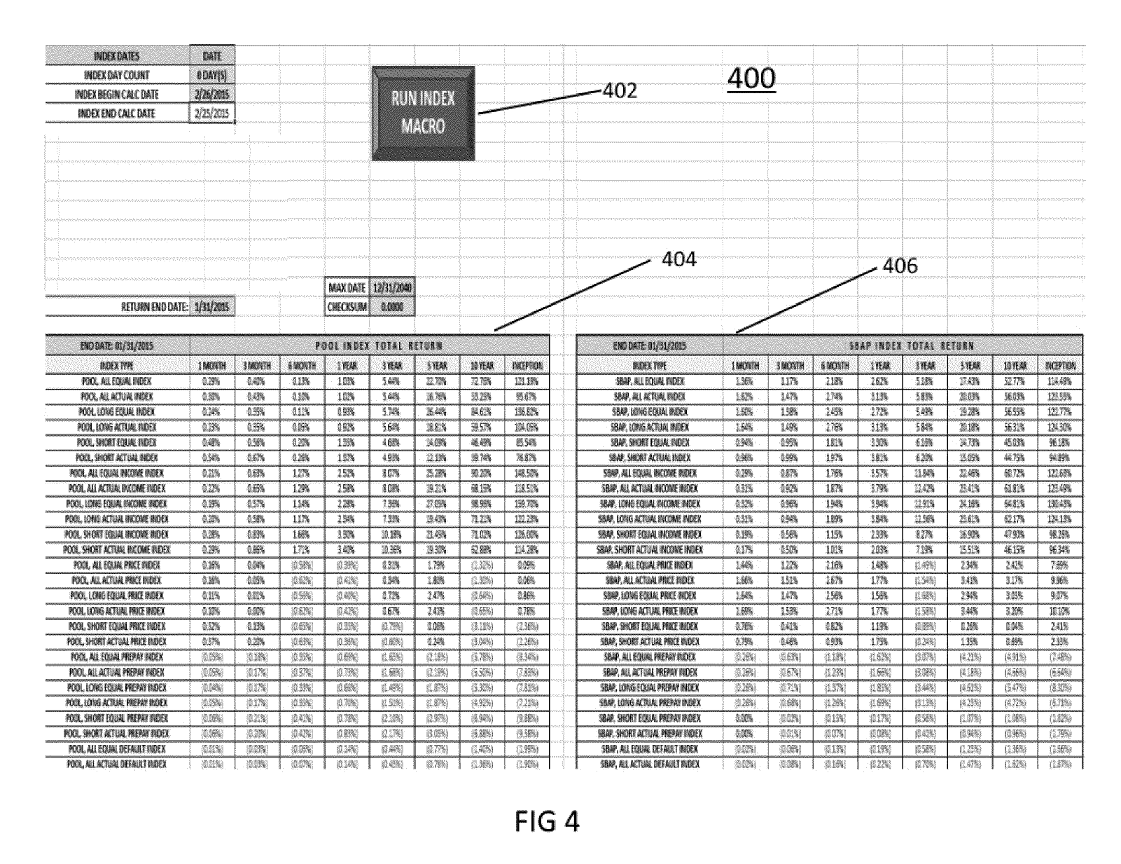

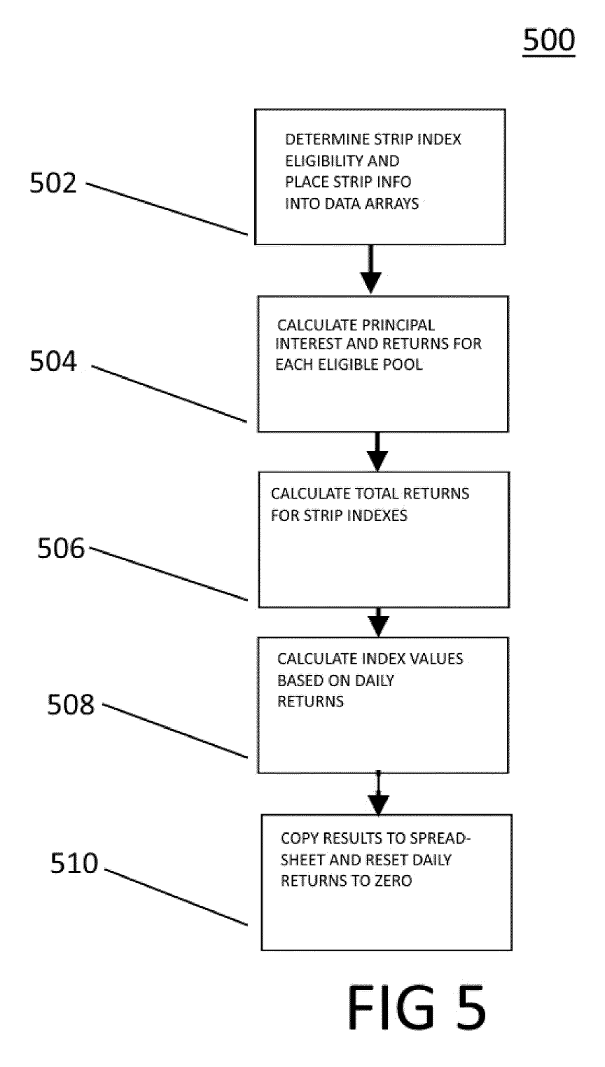

Referring to FIG. 4, a spreadsheet 400 contains the results of the computations that appear in FIG. 5, blocks 502 through 508. The final block 510 of FIG. 5 copies the results of the computation as to the indexes (404, 406) to the spreadsheet 400 depicted in FIG. 4.

FIG. 4, indexes 404, 406 represent a multiplicity of indexes calculated utilizing the system and processes herein. By way of example and not limitation, the spreadsheet 400 calculates a plurality of indexes, such as the U.S. Small Business loan programs referred to as SBAP 504 and SBIC and related composite ones. For example the 504 and SBIC programs are the sister programs to the flagship SBA 7a program, which are used to issue bonds, that can be used to create indexes using the system and processes herein. The composite index is a compilation of the SBA 7 pool, SBA 7a strip, 504 and SBIC indexes. Therefore, the multitude of indexes, 404, 406 are a product of the processes illustrated in FIGS. 2, 4 and 5.

One non limiting embodiment of FIG. 5, represents five separate computer application programming interfaces (API), 502, 504, 506, 508 and 510. A computer program (See, software source code used to execute the processor, below) interface is embodied on a computer readable medium to create the indexes described herein, including: a first interface 502; second interface 504, interface 506, interface 508, interface 510.

The foregoing interfaces may be accomplished via an application's program executed by the computer processor, such as illustrated by FIG. 1, central processor unit (CPU) 106 having a memory 114, an arithmetic logic unit (ALU) 113, and input/output (I/O) devices (not shown) for accessing the databases 103, 104, and 105. The spreadsheet 400 requires in addition to the CPU 106, a graphical user interface (GUI) for displaying the spreadsheet 400, and a switch 402, labeled Run Index Macro, which when activated by clicking a computer mouse over its position, causes the computer process to execute the software programs, described and listed as follows:

### Software Source Code Used to Execute the Processor

In a non limiting embodiment of the non-transitory computer-readable medium the stored code thereon comprising computer-readable instructions, are presented in the following listings:

The code in the following listing is used to carry out the function indicated in FIG. 5, block 502, to determine strip index eligibility and place strip information into data arrays:

| | |
|---|---|
| 1 | ‘BEGIN A |
| 2 | |
| 3 | ‘Pool constants. |
| 4 | For n = 1 To POOLCOUNT |
| 5 | POOLNUMBER(n) = POOLDATA.Cells(n, 1) |
| 6 | STRIPPCT(n) = POOLDATA.Cells(n, 28) |
| 7 | INDEXELIG(n) = POOLDATA.Cells(n, 24) ‘I1 or I2 |
| 8 | |
| 9 | If STRIPPCT(n) > 0 Then ‘Only pools with positive strip percentages |
| 10 | need to be calculated. |
| 11 | |
| 12 | ‘Calculated pool counts. |
| 13 | SACOUNT(CURRENTDATE) = SACOUNT(CURRENTDATE) + 1 |
| 14 | If INDEXELIG(n) = “I1” Then SI1COUNT(CURRENTDATE) = |
| 15 | SI1COUNT(CURRENTDATE) + 1 Else: |
| 16 | SI2COUNT(CURRENTDATE) = SI2COUNT(CURRENTDATE) + 1 |
| 17 | |
| 18 | ‘Balance info. |
| 19 | ORIGACTBAL(n) = POOLDATA.Cells(n, 9) ‘Orig balance |
| 20 | CURACTBAL(n) = POOLDATA.Cells(n, 13) |
| 21 | ACTPPAY(n) = POOLDATA.Cells(n, 12) |
| 22 | ACTDEF(n) = |
| | Round(ACTPPAY(n) * DCRCALC(CURRENTDATE), 2) |
| 23 | ACTVPAY(n) = Round(ACTPPAY(n) − ACTDEF(n), 2) |
| 24 | |
| 25 | If POOLDATA.Cells(n, 11) > 0 Then |
| 26 | PREVACTBAL(n) = POOLDATA.Cells(n, 11) |
| 27 | Else: ‘New Pool. |
| 28 | PREVACTBAL(n) = ORIGACTBAL(n) |
| 29 | End If ‘POOLDATA |
| 30 | |
| 31 | ISSUE(n) = POOLDATA.Cells(n, 21) |
| 32 | MATURITY(n) = POOLDATA.Cells(n, 22) |
| 33 | OIDCPR(n) = POOLDATA.Cells(n, 26) |
| 34 | OIDDISC(n) = POOLDATA.Cells(n, 27) |
| 35 | INIMULT(n) = POOLDATA.Cells(n, 30) |
| 36 | ACTOIDPV(n) = POOLDATA.Cells(n, 32) |
| 37 | ACTAIPOLD(n) = POOLDATA.Cells(n, 53) |
| 38 | ACTAIP(n) = POOLDATA.Cells(n, 55) |
| 39 | COUP(n) = POOLDATA.Cells(n, 37) |
| 40 | NETMGN(n) = POOLDATA.Cells(n, 17) |
| 41 | INDEX(n) = COUP(n) − NETMGN(n) |
| 42 | OLDACTRATIO(n) = POOLDATA.Cells(n, 46) |
| 43 | ACTRATIO(n) = POOLDATA.Cells(n, 47) |
| 44 | ACTPRICE(n) = POOLDATA.Cells(n, 48) |
| 45 | |
| 46 | End If ‘STRIPPCT(n) > 0 |
| 47 | |
| 48 | Next n |
| 49 | |
| 50 | ‘END B |

The code in the following listing is used to carry out the function indicated in FIG. 5, block 504 to calculate principal, interest and returns by sub-indexes for each eligible pool:

| | |
|---|---|
| 1 | |
| 1 | For n = 1 To POOLCOUNT |
| 2 | ‘Check to see if there is a strip. |
| 3 | If STRIPPCT(n) > 0 Then |
| 4 | ‘Set monthly constants and returns for 1st day of the month. |
| 5 | If CURDAY = 1 Then |
| 6 | ‘Principal payments. |
| 7 | ACTPRINPMT = PREVACTBAL(n) − CURACTBAL(n) |
| 8 | ACTSCHPMT = ACTPRINPMT − ACTPPAY(n) |
| 9 | |
| 10 | ‘Interest calculation. |
| 11 | SACTTOTINT(n) = Application.Max(0, Round(ACTOIDPV(n) − ACTAIPOLD(n) + |
| 12 | PREVACTBAL(n) * (STRIPPCT(n) / 360) * (PREVMONTHDAYS − 1), 2)) ‘Act Bal |
| 13 | OID |
| 14 | |
| 15 | ‘Begin value calculations. |
| 16 | SACTBEGVAL(n) = Round(PREVACTBAL(n) * (OLDACTRATIO(n) * |
| 17 | STRIPPCT(n)), 2) + SACTTOTINT(n) |
| 18 | |
| 19 | ‘End value and return calculations. |
| 20 | If SACTBEGVAL(n) > 0 Then |
| 21 | SACTENDVAL(n) = Round(CURACTBAL(n) * (ACTRATIO(n) * STRIPPCT(n)), 2) + |
| 22 | SACTTOTINT(n) |
| 23 | SACTPOOLRET(n) = (SACTENDVAL(n) / SACTBEGVAL(n) − 1) * 100 |
| 24 | End If ‘SACTBEGVAL |
| 25 | |
| 26 | ‘Sub indices |
| 27 | SACTINCRET(n) = 0 |
| 28 | If SACTBEGVAL(n) > 0 Then |
| 29 | SACTPRICERET(n) = ((CURACTBAL(n) * ACTRATIO(n) * STRIPPCT(n)) − |
| 30 | (CURACTBAL(n) * OLDACTRATIO(n) * STRIPPCT(n))) / SACTBEGVAL(n) * 100 |
| 31 | SACTPRINRET(n) = (−ACTPRINPMT * OLDACTRATIO(n) * STRIPPCT(n)) / |
| 32 | SACTBEGVAL(n) * 100 |
| 33 | SACTPPAYRET(n) = (−ACTPPAY(n) * OLDACTRATIO(n) * STRIPPCT(n)) / |
| 34 | SACTBEGVAL(n) * 100 |
| 35 | SACTDEFRET(n) = (−ACTDEF(n) * OLDACTRATIO(n) * STRIPPCT(n)) / |
| 36 | SACTBEGVAL(n) * 100 |
| 37 | SACTVPAYRET(n) = (−ACTVPAY(n) * OLDACTRATIO(n) * STRIPPCT(n)) / |
| 38 | SACTBEGVAL(n) * 100 |
| 39 | SACTSCHRET(n) = (−ACTSCHPMT * OLDACTRATIO(n) * STRIPPCT(n)) / |
| 40 | SACTBEGVAL(n) * 100 |
| 41 | End If ‘SACTBEGVAL |
| 42 | |
| 43 | ‘Not the first day of the month. |
| 44 | Else: ‘CURDAY > 1 |
| 45 | ‘Prior day interest calculations. |
| 46 | SACTTOTINT(n) = Application.Max(0, Round(((ACTOIDPV(n) − ACTAIPOLD(n)) / |
| 47 | 30 + CURACTBAL(n) * (STRIPPCT(n) / 360)) * (CURDAY − 2), 2)) |
| 48 | SACTPREVINT = SACTTOTINT(n) |
| 49 | |
| 50 | ‘Begin value calculations. |
| 51 | SACTBEGVAL(n) = Round(CURACTBAL(n) * (OLDACTRATIO(n) * STRIPPCT(n)), |
| 52 | 2) + SACTTOTINT(n) |
| 53 | |
| 54 | ‘Current day interest calculations. |
| 55 | SACTTOTINT(n) = Application.Max(0, Round(((ACTOIDPV(n) − ACTAIPOLD(n)) / |
| 56 | 30 + CURACTBAL(n) * (STRIPPCT(n) / 360)) * (CURDAY − 1), 2)) |
| 57 | |
| 58 | ‘End value and return calculations. |
| 59 | If SACTBEGVAL(n) > 0 Then |
| 60 | SACTENDVAL(n) = Round(CURACTBAL(n) * (ACTRATIO(n) * STRIPPCT(n)), 2) + |
| 61 | SACTTOTINT(n) |
| 62 | SACTPOOLRET(n) = (SACTENDVAL(n) / SACTBEGVAL(n) − 1) * 100 |
| 63 | End If ‘SACTBEGVAL |
| 64 | |
| 65 | ‘Sub indexes. |
| 66 | SACTPRINRET(n) = 0 |
| 67 | SACTPPAYRET(n) = 0 |
| 68 | SACTSCHRET(n) = 0 |
| 69 | SACTDEFRET(n) = 0 |
| 70 | SACTVPAYRET(n) = 0 |
| 71 | |
| 72 | If SACTBEGVAL(n) > 0 Then |
| 73 | SACTINCRET(n) = (SACTTOTINT(n) − SACTPREVINT) / SACTBEGVAL(n) * 100 |
| 74 | SACTPRICERET(n) = ((CURACTBAL(n) * ACTRATIO(n) * STRIPPCT(n)) − |
| 75 | (CURACTBAL(n) * OLDACTRATIO(n) * STRIPPCT(n))) / SACTBEGVAL(n) * 100 |
| 76 | End If ‘SACTBEGVAL |
| 77 | ‘Running totals. |
| 78 | STOTACTBEGVAL = STOTACTBEGVAL + SACTBEGVAL(n) |
| 79 | TOTACTAIPOLD = TOTACTAIPOLD + ACTAIPOLD(n) |
| 80 | End If 'd = 1 |

The code in the following listing is used to carry out the function indicated in FIG. 5, block 506 to the code in the following listing from calculate total returns for strip indexes:

| | |
|---|---|
| 1 | For n = 1 To POOLCOUNT |
| 2 | |
| 3 | ‘IO Strip Total returns and potential AIP adjustment. |
| 4 | If STRIPPCT(n) > 0 Then |
| 5 | |
| 6 | ‘Check for last day of month. |
| 7 | If CURRENTDATE = ENDMONTH Then ‘Last day of month. |
| 8 | ACTAIPOLD(n) = ACTAIP(n) |
| 9 | End If ‘Month(CURRENTDATE) |
| 10 | |
| 11 | ‘Strip all indexes. |
| 12 | SALLACTTOTRET = SALLACTTOTRET + SACTPOOLRET(n) * |
| 13 | (SACTBEGVAL(n) / STOTACTBEGVAL) |
| 14 | SALLACTINCRET = SALLACTINCRET + SACTINCRET(n) * (SACTBEGVAL(n) / |
| 15 | STOTACTBEGVAL) |
| 16 | SALLACTPRICERET = SALLACTPRICERET + SACTPRICERET(n) * |
| 17 | (SACTBEGVAL(n) / STOTACTBEGVAL) |
| 18 | SALLACTPRINRET = SALLACTPRINRET + SACTPRINRET(n) * |
| 19 | (SACTBEGVAL(n) / STOTACTBEGVAL) |
| 20 | SALLACTPPAYRET = SALLACTPPAYRET + SACTPPAYRET(n) * |
| 21 | (SACTBEGVAL(n) / STOTACTBEGVAL) |
| 22 | SALLACTDEFRET = SALLACTDEFRET + SACTDEFRET(n) * (SACTBEGVAL(n) / |
| 23 | STOTACTBEGVAL) |
| 24 | SALLACTVPAYRET = SALLACTVPAYRET + SACTVPAYRET(n) * |
| 25 | (SACTBEGVAL(n) / STOTACTBEGVAL) |
| 26 | SALLACTSCHRET = SALLACTSCHRET + SACTSCHRET(n) * (SACTBEGVAL(n) / |
| 27 | STOTACTBEGVAL) |
| 28 | |
| 29 | End If ‘STRIPPCT(n) |
| 30 | |
| 31 | Next n |

The code in the following listing is used to carry out the function indicated in FIG. 5, block 508 to calculate index values based on daily returns:

| | |
|---|---|
| 1 | ‘ALL indexes. |
| 2 | SAAI(CURRENTDATE) = SAAI(CURRENTDATE − 1) * (1 + SALLACTTOTRET / |
| 3 | 100) |
| 4 | ‘Income indexes. |
| 5 | SAAIINC(CURRENTDATE) = SAAIINC(CURRENTDATE − 1) * (1 + |
| 6 | SALLACTINCRET / 100) |
| 7 | ‘Price indexes. |
| 8 | SAAIPRICE(CURRENTDATE) = SAAIPRICE(CURRENTDATE − 1) * (1 + |
| 9 | SALLACTPRICERET / 100) |
| 10 | ‘Principal indexes. |
| 11 | SAAIPRIN(CURRENTDATE) = SAAIPRIN(CURRENTDATE − 1) * (1 + |
| 12 | SALLACTPRINRET / 100) |
| 13 | ‘Prepay indexes. |
| 14 | SAAIPPAY(CURRENTDATE) = SAAIPPAY(CURRENTDATE − 1) * (1 + |
| 15 | SALLACTPPAYRET / 100) |
| 16 | ‘Default indexes. |
| 17 | SAAIDEF(CURRENTDATE) = SAAIDEF(CURRENTDATE − 1) * (1 + |
| 18 | SALLACTDEFRET / 100) |
| 19 | ‘Voluntary prepay indexes. |
| 20 | SAAIVPAY(CURRENTDATE) = SAAIVPAY(CURRENTDATE − 1) * (1 + |
| 21 | SALLACTVPAYRET / 100) |
| 22 | ‘Scheduled indexes. |
| 23 | SAAISCH(CURRENTDATE) = SAAISCH(CURRENTDATE − 1) * (1 + |
| 24 | SALLACTSCHRET / 100) |

The code in the following listing is used to carry out the function indicated in FIG. 5, block 510, to copy results to spreadsheet and reset daily returns to zero:

| | |
|---|---|
| 1 | Sheets(“7A PREVIOUS VALUES”).Select |
| 2 | |
| 3 | If CURRENTDATE < ENDDATE Then |
| 4 | CURRENTDATE = CURRENTDATE + 1 |
| 5 | RUNCOUNT = RUNCOUNT + 1 |
| 6 | |
| 7 | ‘Reset variables. |
| 8 | SALLACTTOTRET = 0 |
| 9 | SALLACTINCRET = 0 |
| 10 | SALLACTPRICERET = 0 |
| 11 | SALLACTPRINRET = 0 |
| 12 | SALLACTPPAYRET = 0 |
| 13 | SALLACTDEFRET = 0 |
| 14 | SALLACTVPAYRET = 0 |
| 15 | SALLACTSCHRET = 0 |
| 16 | |
| 17 | ‘Strip index begin values. |
| 18 | STOTACTBEGVAL = 0 |
| 19 | TOTACTAIPOLD = 0 |
| 20 | |
| 21 | GoTo NextDay |
| 22 | End If ‘CURRENTDATE |
| 23 | |
| 24 | ‘Transfer indexes, calcs and data to spreadsheet. |
| 25 | Sheets(“7A INDEX VALUES”).Select |
| 26 | |
| 27 | ‘Strip indices. |
| 28 | Range(“SAAIR”).Value = Application.Transpose(SAAI) |
| 29 | Range(“SAAIINCR”).Value = Application.Transpose(SAAIINC) |
| 30 | Range(“SAAIPRICER”).Value = Application.Transpose(SAAIPRICE) |
| 31 | Range(“SAAIPPAYR”).Value = Application.Transpose(SAAIPPAY) |
| 32 | Range(“SAAIDEFR”).Value = Application.Transpose(SAAIDEF) |
| 33 | Range(“SAAIVPAYR”).Value = Application.Transpose(SAAIVPAY) |
| 34 | Range(“SAAISCHR”).Value = Application.Transpose(SAAISCH) |
| 35 | Range(“SAAIPRINR”).Value = Application.Transpose(SAAIPRIN) |
| 36 | End Sub |
| 37 | Function CURRENTAIP(PREVAIP As Double, BALANCE As Double, COUPON As |
| 38 | Single, OIDPV As Double) As Double |
| 39 | Dim TOTINT As Double, OID As Double |
| 40 | TOTINT = Round(BALANCE * COUPON / 12, 2) |
| 41 | OID = Round(Application.Max(0, OIDPV − PREVAIP + TOTINT), 2) |
| 42 | CURRENTAIP = Round(PREVAIP − TOTINT + OID, 2) |
| 43 | End Function |

What is claimed is:

1. A non-transitory computer-readable medium having stored thereon computer-readable instructions comprising: (1) forming one or more candidate pools from a pool of interest only strip loans; (2) determining one or more selection criteria for including one or more candidate pools in an index; (3) comparing the one or more candidate pools to the one or more selection criteria;
(4) and if the selection criteria are met, then
(5) creating by the computer processor a weighted pool of one or more candidate pools that meet the selection criteria; and
(6) storing by the computer processor said weighted pool by the computer processor;
(8) outputting the weighted pool to an output device, by the computer processor, to provide a benchmark for investor decision making;
(9) otherwise repeating step 3, until all candidate pools have been compared.

2. A computer system comprising: a processor interfaced to a data storage device, that contains instructions that when executed by the processor (1) forms one or more candidate pools from a pool of interest only loans;
(2) determines one or more selection criteria for including one or more candidate pools in an index;
(3) compares the one or more candidate pools to the one or more selection criteria;
(4) and if the selection criteria are met, then
(5) creates a weighted pool of one or more candidate pools that meet the selection criteria; and
(6) stores said weighted pool by the computer processor;
(8) outputs the weighted pool to an output device, to provide a loan portfolio benchmark for investor decision making;
(9) otherwise the instructions repeat step 3, until all candidate pools have been compared.

3. A computer system interface comprising: a first interface for determining strip index eligibility and placing strip information into data arrays and stored in a database; second interface for calculating principal interest and returns for each eligible pool; third interface for calculating total returns for strip indexes; fourth interface for calculating index values based on daily returns; fifth interface for copying results to a spreadsheet and resetting daily returns to zero.

4. The computer system of claim 2, further including an instruction for creating a physical asset for securitizing a loan.

5. The computer system of claim 2, further including an instruction for forming candidate pools by determining if a particular pool states principal and interest.

6. The computer system of claim 2, further including an instruction for forming candidate pools by determining if a particular pool has a maturity greater than a given number of years.

7. The computer system of claim 2, further including an instruction for forming candidate pools by determining if a particular pool has a factor of at least 0.25%.

8. The computer method of claim 2, further including an instruction for forming candidate pools by determining if a particular pool has a pool loan count of at least a given amount.

9. The computer system of claim 2, further including an instruction for forming candidate pools by determining if a particular pool value is greater than a given amount.

10. The computer system of claim 2, further including an instruction for forming said index by weighting the actual outstanding balance of eligible pools.

11. The computer system of claim 2, further including an instruction for forming said index by adjusting the liquidity of the pool for the current month based on the current dollar loan balance of the pool divided by the total amount of the loans balances in the index.

12. The computer system of claim 2, further including an instruction for creating said index by forming one or more sub-indexes determined by distinct maturity cells.

13. The computer system of claim 2, further including an instruction for monetizing the index portfolio by initially entering the index price on the offering side.

14. The computer system of claim 2, further including an instruction for monetizing the index portfolio by entering a price for all pools in the index daily on a bidding side.

15. The computer system of claim 2, further including an instruction for monetizing the index portfolio by calculating yields based upon the last 12 months a constant prepayment rate using a discounted cash flow system.

16. The computer system of claim 2, further including an instruction for monetizing the index portfolio by calculating income return.

17. The computer system of claim 2, further including an instruction for monetizing the index portfolio by calculating a principal return.

18. The computer system of claim 2, further including an instruction for monetizing the index portfolio by calculating a price return.

19. The computer system of claim 2, further including an instruction for monetizing the index portfolio by calculating a daily total return.

20. The computer system of claim 2, further including an instruction for monetizing the index portfolio by calculating an end market value.
